(19) United States
(12) Patent Application Publication
(10) Pub. No.: US 2008/0056341 A1
(43) Pub. Date: Mar. 6, 2008

(54) Finding Low Frequency Random and Periodic Jitter in High Speed Digital Signals

(76) Inventor: Steven D. Draving, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/469,093

(22) Filed: Aug. 31, 2006

(51) Int. Cl. H04B 17/00; H04L 7/00

(52) U.S. Cl. 375/226; 375/355; 375/372

(57) ABSTRACT

Simultaneously measurements of jitter in a high speed signal expected to exhibit both short and long period jitter are made even when the amount of acquisition memory is fixed and cannot be increased to allow storage of consecutive uninterrupted high speed samples for the duration of the longest period. The signal is sampled in repetitive bursts whose sample rate within a burst is high, but whose time between bursts is long enough to prevent a Segmented Acquisition Memory being filled, and a Segmented Acquisition Record from being completed, until a period of time that is long enough to encompass measurement of the long period jitter has transpired. The Segmented Acquisition Record is analyzed by a technique that tolerates the ‘natural holes’ in a TIE Record caused by the absence of a transition between consecutive identical logical values. That technique is extended to allow the ‘dead space’ between bursts to appear as ‘artificial holes’ that also do not poison or corrupt the extraction of the desired jitter description.

### REFERENCE TO RELATED PATENT DOCUMENTS

The subject matter of this patent application is related to that of U.S. patent application Ser. No. <as yet unknown> entitled FINDING RANDOM JITTER IN AN ARBITRARY NON-REPEATING DATA SIGNAL and filed on 14 Jul. 2006 by Steven D. Draving and Allen Montijo, and which has been assigned to Agilent Technologies, Inc. For the sake of brevity and yet guard against unforeseen oversights, FINDING RANDOM JITTER IN AN ARBITRARY NON-REPEATING DATA SIGNAL is hereby incorporated herein by reference.

The subject matter of FINDING RANDOM JITTER IN AN ARBITRARY NON-REPEATING DATA SIGNAL is in turn related to that of two other U.S. patent applications: application Ser. No. 10/978,103 entitled METHOD OF FINDING DATA DEPENDENT TIMING AND VOLTAGE JITTER IN AN ARBITRARY DIGITAL SIGNAL IN ACCORDANCE WITH SELECTED SURROUNDING BITS filed 29 Oct. 2004 by Steven D. Draving and Allen Montijo and assigned to Agilent Technologies, Inc.; and application Ser. No. <unknown> entitled FINDING DATA DEPENDENT JITTER WITH A DDJ CALCULATOR CONFIGURED BY REGRESSION filed 29 Jun. 2006 by Steven D. Draving and Allen Montijo and assigned to Agilent Technologies, Inc. These latter two patent applications describe methods of discovering values of Data Dependent Jitter that can plausibly be ascribed to the various bits in an arbitrary digital signal. For the same reasons as above, and because the subject matter of both the instant patent and FINDING RANDOM JITTER IN AN ARBITRARY NON-REPEATING DATA SIGNAL presumes that any Data Dependent Jitter has already been found, METHOD OF FINDING DATA DEPENDENT TIMING AND VOLTAGE JITTER IN AN ARBITRARY DIGITAL SIGNAL IN ACCORDANCE WITH SELECTED SURROUNDING BITS and FINDING DATA DEPENDENT JITTER WITH A DDJ CALCULATOR CONFIGURED BY REGRESSION are each hereby incorporated herein by reference.

### PLAN OF THE DESCRIPTION

This patent is similar in subject matter to that of the incorporated FINDING RANDOM JITTER IN AN ARBITRARY NON-REPEATING DATA SIGNAL. In that prior application a particular technique is used to discover Total Jitter and isolate therein another type of ‘component’ jitter called Random Jitter while using an arbitrary Test Pattern for which successive repetitions thereof were not required. Those tasks involve a paradigm for characterizing Total Jitter through assumptions about the nature of different kinds of jitter, and various operations to perform the discovery and separation. We are interested, in part, in a comparable set of activities, and especially so since the technique set out in FINDING RANDOM JITTER IN AN ARBITRARY NON-REPEATING DATA SIGNAL is particularly tolerant of something called ‘holes’ (the absence of an input signal edge or transition caused by consecutive logical values in the data). Accordingly, much of the motivation for how to initially proceed is the same here as it was for FINDING RANDOM JITTER IN AN ARBITRARY NON-REPEATING DATA SIGNAL, although our use of what accounts for that tolerance will go beyond what is set out there. Given this similarity in the ‘starting place,’ we chose to rob the first dozen or so pages from FINDING RANDOM JITTER IN AN ARBITRARY NON-REPEATING DATA SIGNAL, and also its first three figures, and then repeat that material here in as condensed and streamlined a form as we could, while also incorporating some necessary changes that steer toward a new and different technique that lends itself to the measurement of long period phenomena for which there is at hand insufficient memory for the measurement in a conventional manner of certain ‘long period’ phenomena (low frequency jitter).

The borrowed material essentially describes how the Total Jitter is discovered in the first place, and the paradigm for construing its components. Subsequent (new) material deals in detail with only aspects of the new technique for achieving the relaxed memory requirement. As for our ‘compact re-use’ of FINDING RANDOM JITTER IN AN ARBITRARY NON-REPEATING DATA SIGNAL despite its also being incorporated by reference, we prefer that this application be as self-contained as reasonably possible. For us to assume that the reader is inclined to consult and digest all that stuff (not to mention what it incorporates!) would be asking him or her to do more than is actually necessary. Furthermore, we would find ourselves making many references to material that was in other documents intended to accomplish different tasks, and with no easy way to eliminate some things not of interest here, or re-cast other things that are of interest into terms subsequently found to be more pleasing or satisfactory. The opportunities for confusion and aggravation would abound, all at the reader's expense. So we didn't make that rather cavalier assumption regarding the reader's inclination, and opted instead for extending an invitation to take a drink from just a miniature fire hose.

As it is, we are going to draw a ‘cordon sanitaire’ around the notion of Data Dependent Jitter and eventually assume that it has been suitably defined, found and removed from Total Jitter to leave something that is Deterministic Jitter (i.e., Periodic Jitter or any other form of ‘regular’ jitter not correlated to the data) combined with Random Jitter, and from which we desire to isolate and separate the component Random Jitter from the component Deterministic Jitter. It is in support of this encapsulation of the task of finding Data Dependent Jitter that METHOD OF FINDING DATA DEPENDENT TIMING AND VOLTAGE JITTER IN AN ARBITRARY DIGITAL SIGNAL IN ACCORDANCE WITH SELECTED SURROUNDING BITS and FINDING DATA DEPENDENT JITTER WITH A DDJ CALCULATOR CONFIGURED BY REGRESSION have been incorporated by reference. (We should note, however, that there are yet other ways of finding Data Dependent Jitter, some of which are described in the Background set out in the incorporated METHOD AND APPARATUS USE RE-SAMPLED TIE RECORDS TO CHARACTERIZE JITTER IN A DIGITAL SIGNAL.) This business of variously finding Data Dependent Jitter is rather complicated and fussy, but if we proceed carefully, we can avoid having to deal with it here in any real detail.

### INTRODUCTION AND BACKGROUND

There have been several techniques developed for the measurement of different types of jitter by various kinds of electronic test equipment. By and large, this electronic test equipment is of the sampling variety, in that brief samples of a signal's instantaneous value are taken, digitized and stored in a memory. In the more capable instances of such equipment the samples are taken at a rate sufficient to meet the Nyquist requirement for signals in the multi-gigahertz range. Examples would include modern ‘real time’ DSOs (Digital Sampling Oscilloscopes) with bandwidths in the ten to twenty Gigahertz region.

Once a DSO's digitized signal values are stored in an Acquisition Memory as an Acquisition Record, various algorithmic processes executed by an embedded system can analyze the data to extract desired results. For example, DSP (Digital Signal Processing) techniques can be used to “fill in the dots” between samples to provide a pleasing and faithful reconstruction of a segment of the Acquisition Record as a trace image stored in a frame buffer that is subsequently displayed on a CRT (Cathode Ray Tube) or some type of flat panel display. Such algorithmic processing, and the attendant issues of triggering and navigation within an Acquisition Record are the stock-in-trade of a laboratory grade DSO. It is common for DSOs to also perform various sorts of measurements upon the waveforms they have captured. Jitter measurements have, in recent times, become a member of that family of measurements for top of the line DSOs.

For the first few years of the DSO's development, the major emphasis was on improving the bandwidth and exploiting the potential for powerful user interfaces that took advantage of an unprecedented ability to both ‘see and remember’ what led up to an event of interest. (The Acquisition Record is being formed anytime the ‘scope is ‘running’ and if the triggering event ends that process, then the Acquisition Record lets the user ‘see’ in the direction of ‘negative time.’ Also, it took a while before user interfaces to the feature-rich DSO became—at least in the opinion of some—as easy to use as their now nearly obsolete analog predecessors.) It has only lately been the case that DSOs with really ‘deep memory’ have come onto the scene. By ‘deep memory’ we mean that the length of the Acquisition Record can be large enough to store several thousand cycles of the fastest signals. Say, many hundreds of megabytes for samples taken at the highest sampling rates. Those ‘highest sampling rates’ are many(!) Times faster than the highest memory cycles times of even high performance commercial computer memory.

Now, one not familiar with what goes on ‘under the hood’ (so to speak) of a DSO may wonder just why it is that having ‘deep memory’ took so long to arrive and is touted as an advance worth noting. It is not so much that it is hard to appreciate its utility, but those that are unfamiliar may not appreciate that, unlike in a PC's (Personal Computer's) or Work Station's environment, it is not simply a matter of waiting for the microprocessor and memory manufacturers to provide chipsets with more bits of addressing, and then adjusting the motherboard to carry more traces for those extra addressing bits. No, indeed. Leaving aside the significant issue of getting the signal digitizing mechanism itself to go ever faster (no small feat in itself) there are good technical reasons why addressing and storing in memory is, at present anyway, inherently slower than the fastest sampling and digitizing. Accordingly, the DSO community has spent much engineering effort to find ways to either:
(A) Get interleaved collections of merchant ‘high speed’ memory to operate at speeds many times faster than the cycle rate that the individual memory chips support; or
(B) Develop custom memory chips that are fast and closely coupled to an associated digitizer.

In each of these approaches the natural-physical distance between things is an (additional) enemy that limits the speed of combined operation, and it turns out that these architectures do not scale up gracefully to allow the simple addition of more memory. It is not our purpose here to describe in detail why this is so and how to “try to do it anyway.” Our purpose begins with an acknowledgment that such is the case, and that save perhaps for some secret government project with unlimited funding, a (commercial) DSO of high bandwidth is going to have a maximum size for its Acquisition Memory, as determined by what is deemed practical by the manufacturer of that DSO. (We will concede that if one were to contemplate a system with less than maximum bandwidth that sampled at a low enough rate that the native memory cycle rate of the Acquisition Memory could match it in sustained operation, then memory size is limited technically, in principle, only by issues related to addressability. Once again, our present premise is to the contrary: that we need to sample high speed signals at the highest obtainable sampling rates.)

Given a maximum practical size for the Acquisition Memory, there will be for a high bandwidth real time DSO a corresponding limit on the number of consecutive high speed samples that the ‘scope can store. As a consequence, it will be able to take a ‘complete’ or undivided collection of consecutive high speed samples for just some limited length of time, Tₘₐₓ. Now suppose that we desire to make jitter measurements on signals that justify such high speed sampling. Such justification might be that the signals are themselves very fast, or that the amounts of jitter are, in terms of absolute time, quite small. Either way, a jitter measurement will need to deal with tiny time intervals, which means using high rates of sampling. As stated in our opening sentence of this section, ways to make various jitter measurements have been developed, and they are applicable to the environment just described.

But now also suppose that it comes to our attention that some of the jitter we would like to measure has an associated period that is several times the value of, or at least longer than, Tₘₐₓ. This is a true predicament, because the sampling regime we have described acts as a high pass filter that discriminates against such long period signals. The Nyquist-Shannon Sampling Theorem tells us that uniformly spaced discrete samples upon a bandwidth limited signal are a complete representation of that signal if the sampling rate is at least twice per period of the signal. Accordingly, we definitely would prefer that we obtain samples that are distributed along the entire length of such long period jitter components. Rounding up the usual suspects, we find that:
(A) If we slow the sample rate to make Tₘₐₓ larger with the existing memory size we severely compromise our ability to resolve the tiny time intervals of interest. We may assume that our SUT (System Under Test) is not infested with jitter that exhibits BIG variation in time intervals, just tiny ones. (We mustn't fall into the trap of thinking that merely because the period of a jitter component is long that the amount of variation it causes in the time placement for the edges of a signal is large. The period of a jitter component is the time between successive peak—or minimum—variations, and the variations themselves can be tiny!) And as the UI (Unit Interval) of our high speed signal is also tiny, we have no choice but measure the jitter in terms of tiny time intervals. So we have to continue to sample at a high rate.
(B) We cannot simply put more memory to use so that Tₘₐₓ is, at the outset, large enough at an existing high or maximum sample rate. Unfortunately, our premise is that the size of the Acquisition Memory is ALREADY at its practical limit, whether for mere economic considerations or for genuine technical impracticalities attached to increasing its size. We are forced to deal with the consequences of the message: “NO MORE MEMORY!”

Hmmm. Message received. Yet there remain indications that there is ‘long period’ jitter in the System Under Test, waiting for us to measure it. But how to do it?

### SIMPLIFIED DESCRIPTION

A solution to the problem of measuring long period random and periodic jitter in a high speed signal with a fixed amount of acquisition memory that cannot be increased to make Tₘₐₓ long enough (in view of the Sampling Theorem) to accommodate the longest period of the expected jitter, is to sample in repetitive bursts whose sample rate within a burst is high, but whose time between bursts of sampling is long enough to prevent the Acquisition Memory being filled (and hence the Acquisition Record from being completed) until a period of time that is long enough to encompass measurement of the long period jitter has transpired. To do this we shall treat the Acquisition Memory as if it were made of a suitable number of segments (with one segment per burst). We shall refer to an Acquisition Memory filled in such bursts as a Segmented Acquisition Memory, and to its content as a Segmented Acquisition Record. There remains the issue of how to analyze the data thus collected as a Segmented Acquisition Record.

It turns out that the notion of a ‘hole’ in a TIE (Time Interval Error) Record for a data pattern is of interest. A ‘hole’ is two or more consecutive logical values for the signal causing an absence of corresponding transitions and the attendant absence of error information about placement of those missing edges. In one sense, such a ‘natural hole’ represents the absence of data that is the feedstock for any jitter measurement process. On the other hand, to insist that there be no natural holes is equivalent to requiring that the applied data be alternating ONEs and ZEROs. Such a requirement is undesirable. If enforced, it would preclude making certain types of jitter measurements, such as that for DDJ (Data Dependent Jitter), where certain data patterns are required. It would be much more convenient if the jitter measurement techniques in use were such that an entire suite of jitter measurements of all types could be made from one suitable TIE Record, rather than having to use this kind of data for that measurement, and another kind for a different measurement, and so on.

Some jitter measurement techniques are less affected by natural holes than are others. That is, while a hole represents the absence of an opportunity to contribute to an overall result, in these less affected techniques natural holes are tolerated in a graceful manner: they do not poison or otherwise corrupt any meaning that can still be extracted from the rest of the data. At worst, there might be for these hole tolerant techniques an urge on our part to merely increase the length of the test pattern to compensate for the ‘lost transitions’ (holes) in order to maintain a certain level of confidence for statistical inferences that might be made. We shall show that, properly approached, the ‘dead space’ between the bursts in a Segmented Acquisition Record can be construed as ‘artificial holes’ and thus accommodated by an appropriate jitter measurement technique that is tolerant of the ‘natural holes’ that occur in the data, anyway. Accordingly, we arrange to extend and further exploit the jitter measurement techniques set out in FINDING RANDOM JITTER IN AN ARBITRARY NON-REPEATING DATA SIGNAL and apply them to a Segmented Acquisition Record.

### BRIEF DESCRIPTION OF THE DRAWINGS

FIG. 1 is a prior art diagram illustrating a preferred manner of decomposing Total Jitter into Deterministic Jitter and Random Jitter;

FIG. 2 is a prior art diagram illustrating that a histogram representing Total Jitter can be decomposed into separate probability distributions representing Deterministic Jitter and Random Jitter;

FIG. 3 is a prior art diagram illustrating the notion of a TIE Record for a Data Acquisition Record and a prior art histogram produced therefrom to estimate Total Jitter;

FIG. 4 is a simplified flowchart describing a segmentation step that introduces ‘artificial holes’ into the environment of the ‘naturally’ hole tolerant Timing Jitter measurement algorithm of FIG. 6 to allow measurement of long period jitter;

FIG. 5 is a diagram illustrating certain preliminary steps associated with performing a method that finds Timing Jitter in an arbitrary, and possibly non-repeating, data signal whose samples have been stored in a segmented Acquisition Memory; and

FIG. 6 is an illustrated flowchart of certain remaining steps, subsequent to those of FIGS. 4 and 5, for performing a method that finds both short and long period Timing Jitter in an arbitrary, possibly non-repeating, data signal.

### DETAILED DESCRIPTION

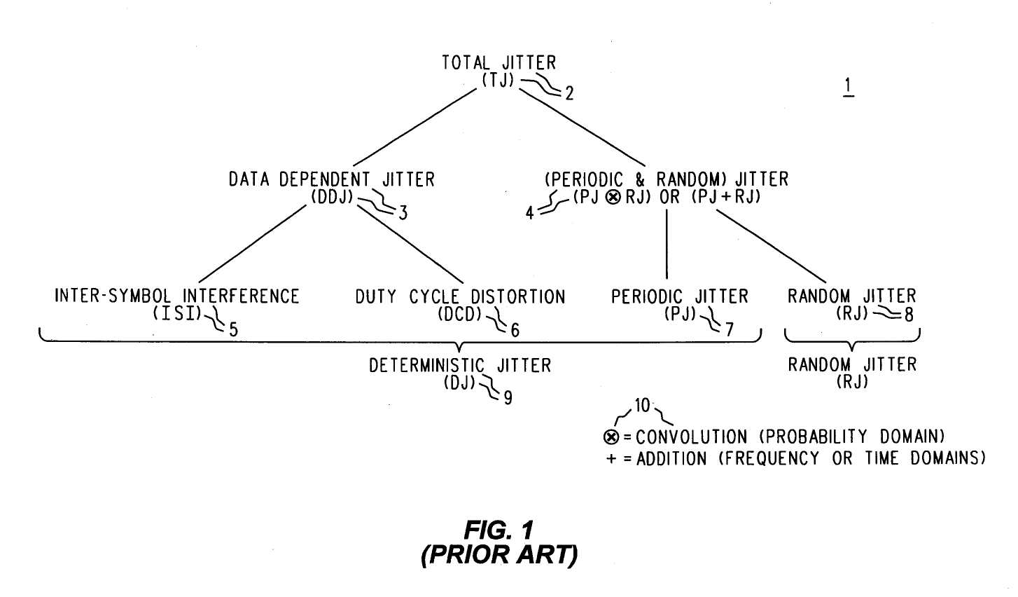

Refer now to FIG. 1, wherein are shown some relationships between the various types of (timing) jitter with which we shall be concerned. FIG. 1 is a diagram 1 describing a paradigm we shall use in understanding jitter. It begins at the top with the notion that there is something called TJ (Total Jitter) 2. It represents all the aggregate jitter that is present in the system being measured. It is the thing that, while in principle can be measured by direct observation, takes too long to discover by such a brute force method.

In the paradigm of FIG. 1, TJ (2) is composed exactly of two component parts, one of which we call DDJ (3) (Data Dependent Jitter) and the other of which is the combination (4) of PJ & RJ. Note that both of these representations for jitter are probability density functions. This leads us to the observation, which will be familiar to those who operate with probabilities, that the proper method of combining, or summing, two probability density functions such as 7 and 8 is convolution, which operation is indicated by the symbol \textcircled{×} (10). To describe the same combination expressed in the time domain or in the frequency domain, a more appropriate notation is PJ+RJ. We shall have occasion to use both notations, depending upon the circumstances.

RJ 8 is assumed to arise for inescapable natural reasons, after the fashion of thermal noise or quantum effects, and is further assumed to be Gaussian in nature. PJ 7 is jitter that has a strong periodic content, say, for example, that a strong periodic signal from another-system is coupled via cross talk into the system being measured. It might have no correlation whatsoever with events in the SUT (System Under Test), but is nevertheless regular. And while the presence of PJ in our paradigm allows for this sort of thing, we don't demand that it actually be there. That is, in some SUTs there might not be any detectable PJ.

The other component of TJ 2 is DDJ 3. This is jitter that is caused by, or is correlated with, the particular patterns of bits in the data being transmitted. It turns out that there are mechanisms that allow what has already been sent, or that will be sent, to affect the reception of the bit currently being received. (‘Already been sent’ seems benign enough; perhaps local heating or cooling related to certain activity in the data disturbs thresholds or alters rise or fall times. But ‘will be sent’ might seem as if it requires an effect to precede its cause. Not to worry. The idea is that a complex transmitting mechanism, such as a SERDES, say, has a highly pipelined parallel architecture with busses interconnecting FIFOs and registers all susceptible to cross talk, and that the complex transmitting mechanism DOES ALREADY CONTAIN the evil data that is the ‘cause.’ That data just hasn't been sent yet over the transmission path to the receiver, and the jitter will get into the data as it is sent. Thus, causation still precedes its effect, and no mysterious metaphysics is required.) Since these phenomena are already reported in the literature, we needn't dwell on them further. One measure of such DDJ is ISI 5 (Inter-Symbol Interference) and another is DCD 6 (Duty Cycle Distortion). Those seeking further information about these measures of jitter are referred to some product literature cited in an application entitled METHOD AND APPARATUS USE RE-SAMPLED TIE RECORDS TO CHARACTERIZE JITTER IN A DIGITAL SIGNAL (Ser. No. 10/929,194, filed 3 Aug. 2004), which is variously incorporated in some of the applications incorporated herein.

Finally, we group ISI, DCD and PJ together as DJ 9 (Deterministic Jitter). It will be appreciated that while the DDJ portion of DJ is separable into ISI and DCD, those components are not necessarily independent nor mutually exclusive, and they generally do not combine by convolution. In any event, the intent of this grouping is that DJ 9 is all jitter that is not truly random in nature (RJ, 8), but that is either somehow correlated with the data, or is downright periodic, which in neither case fits our intuitive notion of ‘random.’ An important difference between RJ and DJ is that RJ has (in principle) a PDF (Probability Density Function) with an infinite domain, while DJ has a PDF whose domain is bounded.

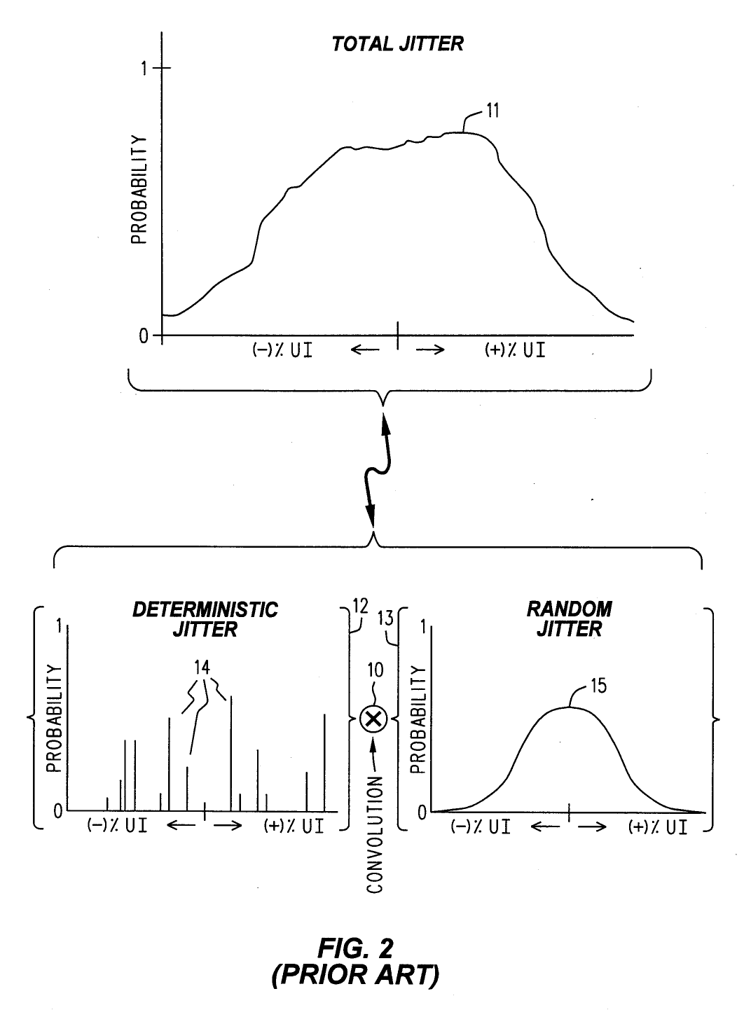

Refer now to FIG. 2, wherein is shown a histogram 11 representative of Total Jitter. Total Jitter is the actual aggregate amount of jitter the system exhibits, from whatever source. It is what is directly measurable, although it generally takes way too long to do so directly for the small amounts of jitter that are at present considered reasonable. Histogram 11 is not one that has been directly obtained by brute force measurements, although suppose for a moment that it is. Such a histogram is indeed an item that we would like to have (even if we don't actually have it), and we are showing it (11) in the abstract and in the spirit of saying “Well, there exists some histogram that describes the Total Jitter, and let's suppose that this (11) is it.” It is a histogram of probability versus percent error in UI. That is, the amounts of jitter, while they could be described as absolute times, are instead described as position errors that are early or late arrivals in terms of the UI. The probability axis represents the likelihood that an edge occurred with that amount of position error. Now, in this regard, it may be tempting to think that the only possible errors are fractions of a UI. For some systems this would be a reasonable assumption. But we are operating at very high speeds for data streams of significant length. A slight drift in the data rate can accumulate errors to produce a transition location having more than a UI of error, when compared to the ideal correct time of signal transition.

To continue, then, our plan is to assert that there exists some histogram 11 describing Total Jitter, and argue that, whatever it is, that Total Jitter can be decomposed into Random Jitter and Deterministic Jitter. That is, we will assume that such a decomposition is a true partition of the Total Jitter: i.e., any type of jitter is either in one category or the other, and that none is in both. This leads us to assert that there is some representation 12 for Deterministic Jitter 9 that can be combined with a representation 13 for Random Jitter 8 that “adds up to” the histogram 11 for the Total Jitter. We note that we expect the Deterministic Jitter to usually be discrete and static, as indicated by the collection of spectra-like lines 14 (note that we are not accusing them of being spectral components in the signal . . . just that their shapes resemble a displayed spectra). We also expect the Random Jitter to follow some plausible distribution found in nature, such as a Gaussian one represented by distribution 15.

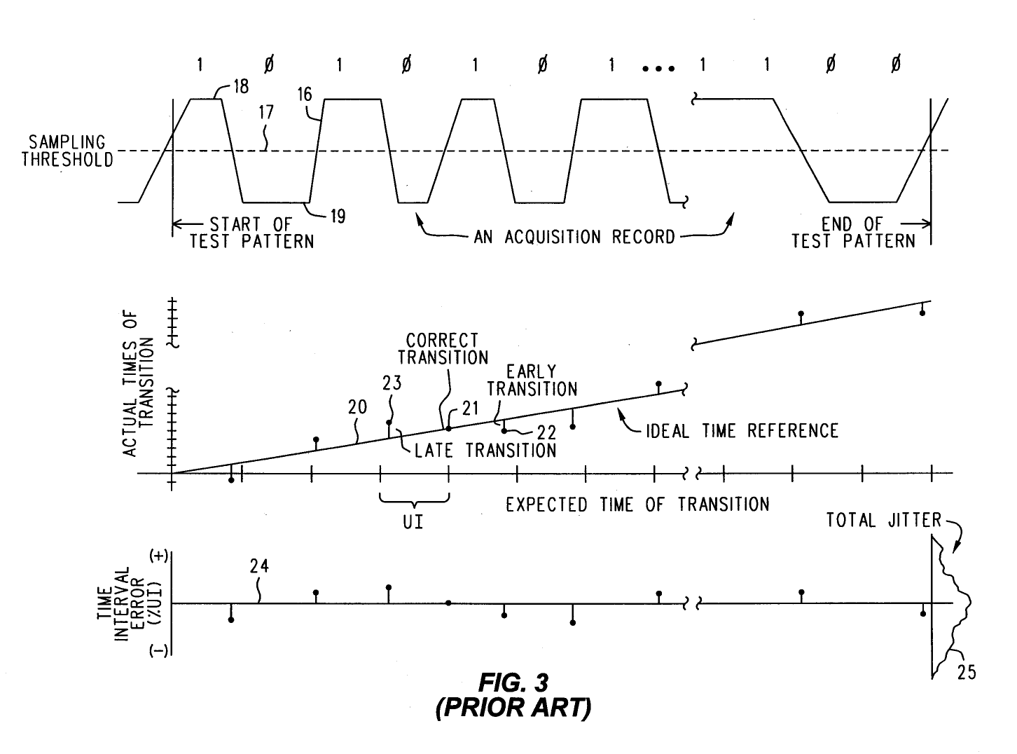

In FIG. 3 an acquired data waveform 16 is depicted, along with a threshold 17 against which the data waveform 16 is compared for determining the logical values of TRUE and FALSE in a test pattern. In this (non-segmented) example we assume that long period jitter can be ignored, and that the Acquisition Record it represents is ‘continuous.’ The portion 18 of data signal 1 conveys a logical value of TRUE (a logic ONE), while portion 19 conveys a logical value of FALSE (a logic ZERO). We are not in this figure indicating how the time variant waveform of the data signal 16 is measured. That can be done in different ways, depending upon the nature of the test equipment. As an example that we are interested in, a real time DSO would digitize discrete sampled locations of the waveform at known times there along. (It will be appreciated that for high speed signals there may be only ten or less samples per cycle, but that this does not present a problem, since the 'scope relies on a DSP (Digital Signal Processing) implemented reconstruction filter protected by the Nyquist limit to ‘fill in the dots.’) In any event, the test equipment would ultimately have in its acquisition memory a data structure called an Acquisition Record that represents the waveform of the data signal. We also are not in this figure indicating how the logical pattern in use is discovered from the reconstructed waveform according to the relationship between the waveform of the data signal 16 and the threshold 17. The pattern might, by simple agreement, be known ahead of time. To enforce that might, however, be quite inconvenient. Post processing by the DSO of the Acquisition Record 1 can reveal the sequence of logical values it contains, should that be desirable (which for us it will be). Another possibility is coupling the input signal to an actual hardware comparator having an actual threshold that produces an actual collection of logical ONEs and ZEROs from time stamped transitions (which would be how a Timing Analyzer acquires data, and in which case there probably would not be any separate samples that need DSP).

To continue in the DSO case, the samples representing the Acquisition Record 16 can be processed with DSP techniques and/or interpolation to discover with suitable precision the locations along a time axis when an edge in the data signal crossed the threshold 17. With a correctly set threshold (very probably one set in the middle of the signal's voltage excursion), jitter, if it is present, will cause the time locations of the threshold crossings to vary from the ideal sequence of consecutive UIs. This is shown in the middle portion of the figure, wherein is depicted an ideal time reference line 20, appended to which are indications of correct (21), early (22) and late (23) transitions. The lengths of these appendages are indicative of the degree of error. It is clear that if a Timing Analyzer provided time stamped transition data (as opposed to a DSO's digitized samples), the same correct/early/late actual time of transition information can be produced.

The process of discovering the Time Interval Error for an edge involves knowledge of what the UI ought to be, and that information might arise from how a clock signal that is supplied by the SUT, or that is recovered from its data, exhibits a transition in a particular direction. It might involve the phase locking of a time base in the DSO or Timing Analyzer to one in the SUT, since even precision laboratory grade time bases that are independent can be expected to drift relative to one another by amounts that correspond to significant amounts of jitter in a high speed system.

As an aside, we wish to point out that, although FIG. 3 is drawn as though each ideal UI is expected to be the same length of time, this need not be the case. There are systems where the UI is varied on purpose. If we were to measure jitter in such a system we would presumably be informed about the nature of such variations, and could still correctly determine the errors that occur. We might then normalize these errors to be expressed as a percentage of expected UI, so that the members of a collection of such transition data are commensurable.

The bottom portion of FIG. 3 is a representation of a TIE (Time Interval Error) Record 24 that is prepared from the information depicted in the parts of the figure already described. The TIE Record is a description of the observed jitter, and corresponds to Total Jitter. Upon reflection, it will be appreciated that such a TIE record 24 is, in terms of information content, superior to a histogram, such as 11 in FIG. 2, in that actual instances of jitter are still embedded in their surrounding circumstances. (This is not to impugn the utility of the histogram 11; it readily conveys useful information by its shape that remains concealed within a TIE record such as 24.) One prior art technique constructs a histogram from the TIE data, and then uses that histogram as the basis for a model from which to make estimates of other types of jitter.

Henceforth, when we refer to a TIE Record, we shall have in mind a data structure implemented in the memory of suitable test equipment, such as a real time DSO or Timing Analyzer, which contains time interval error information of the sort depicted in the lower third of FIG. 3 (although without the histogram at the right-hand end), and that has been derived from circumstances similar to those set out in the top two portions of that figure.

Given that we had an Original Time Interval Record 24 such as shown in FIG. 3, the measurement, separation and analysis of RJ and DJ in a System Under Test would begin with the production of a suitably long digital arbitrary Test Pattern which may contain a random sequence of bit values, some other sequence of bits, or, which might be actual live data over which there is no external control. An Acquisition Record describing the sequence of logical values along a time axis would be made of the entire arbitrary Test Pattern. A complete Original Time Interval Error (TIE) Record 24 is then made from an inspection of the locations of the edges in the Acquisition Record.

While such a continuous (‘short?’) Original TIE Record is not suitable of extracting long period jitter, we are well justified in asserting that it will do just fine for the discovery of DDJ (assuming, that is, that none of DDJ is ‘long’). So, let us begin by forming such a continuous Original TIE Record and discovering DDJ. See the incorporated METHOD OF FINDING DATA DEPENDENT TIMING AND VOLTAGE JITTER IN AN ARBITRARY DIGITAL SIGNAL IN ACCORDANCE WITH SELECTED SURROUNDING BITS or FINDING DATA DEPENDENT JITTER WITH A DDJ CALCULATOR CONFIGURED BY REGRESSION for exemplary information concerning how this may be accomplished. Such discovered DDJ can then be removed from the Original TIE Record. That is, once the DDJ for each, or whatever various ones, of the transitions in the Test Pattern has been discovered an Adjusted TIE Record could be made from the Original TIE Record by altering each entry in the latter by the amount of DDJ associated with each entry. This is indeed eminently doable, although in and of itself, it does not help us with the problem of long period jitter where an Original (and non-segmented) Acquisition Record is too short. However, it occurs to us that if we can adjust a non-segmented Original Acquisition Record for DDJ, then we ought to be able to adjust a segmented one that (owing to ‘hole tolerance’) is long enough. We are getting ahead of ourselves, since we have not yet described a Segmented Original Acquisition Record. At present it is sufficient to say that such ‘adjustment’ is entirely comparable. (What is more, and to risk an opportunity for confusion, it may well be possible to dispense with the ‘short’ version of the Original Acquisition Record, only ever acquire a ‘long’ Original Segmented Acquisition Record, and accurately find DDJ from it anyway, and then proceed to adjust that to form an Adjusted Segmented Acquisition Record.)

Let us temporarily set aside the worries of long period jitter, and gain an appreciation of a jitter measurement and separation technique that is ‘hole tolerant.’ Assuming that we now have an Adjusted TIE Record for which DDJ has been defined, isolated and removed from a continuous Original (think: TJ) TIE Record (that is ‘short’ in the sense that it is ‘not long enough’ to preserve long period information), what remains in the Adjusted TIE Record is the effect of Periodic Jitter combined with Random Jitter (denoted by PJ+RJ). It is this remnant combination that we wish to separate into individually identified amounts for PJ in isolation and for RJ in isolation.

We would like to perform this RJ−PJ separation in the frequency domain using a threshold-based technique similar to that used in the aforementioned METHOD AND APPARATUS USE RE-SAMPLED TIE RECORDS TO CHARACTERIZE JITTER IN A DIGITAL SIGNAL. However, the presence of holes in the Adjusted TIE Record corrupts the spectrum too much to use the simple single-threshold technique described therein. The solution to this problem lies in an appreciation of the following relationship: the FT of the Adjusted TIE Record (with holes) is equivalent to the FT of the Adjusted TIE Record without holes convolved with the FT of the TP (Transition Pattern). That is, TP is a ‘derivative’ waveform record that is equal to ONE where transitions are present in the Test Pattern and equal to ZERO where transitions are absent. We do indeed appreciate that relationship because the Adjusted TIE Record (with holes) would be equivalent to an Adjusted TIE Record without holes (if such there were) as ‘multiplied’ by the TP.

Since we can't simply de-convolve the FT of the TP-combined-with-jitter and by applying a ‘one-size-fits all’ PJ-related threshold to remove PJ, we shall perform a ‘synthetic’ de-convolution by the application of a more sophisticated PJ-related threshold, as implemented by the following iterative technique. First, ensure that the logical sequence of ONEs and ZEROs in the measured Test Pattern is at hand; we will need it, so re-construct it from the sampled data, if it is not already known. Now calculate the PDS (Power Density Spectrum) of the PJ+RJ, and determine a threshold applicable thereto that indicates the presence of a frequency component that is likely to be associated with PJ. Identify in the PDS the frequency component with the largest amplitude that also exceeds the threshold, if there is one. If there is not such a frequency component, then there is no significant PJ and all of what was thought to be PJ+RJ can be taken as RJ, and we are finished separating RJ.

If, on the other hand, there is an identified frequency component that exceeds the threshold, take the one with the largest amplitude, calculate the convolution of that frequency component with the FT of the Transition Pattern (TP) in the data of the Test Pattern. Even though there may well be more contributors to PJ, this identifies the jitter for this particular contributor, as if it did occur in isolation. Surely this amount is ‘part of’ the PJ+RJ for which we have a description. Let us make a note of this partial amount, and then remove it from the FT of the PJ+RJ to produce a diminished PJ+RJ (which is an improved approximation for RJ). Now take the diminished PJ+RJ as the next PJ+RJ and calculate its PDS as before, and recalculate a next threshold, and find (if there is one) a next largest frequency component. As before, we then convolve the FT of that next largest frequency component with the FT of the TP to find another ‘part of’ PJ+RJ that is noted and then removed, and so forth with continued iterations, until there are no further PJ components identifiable in the newest PDS. At this point we are justified in believing that we have ‘extracted’ all significant PJ from PJ+RJ, and have a remnant RJ PDS with an associated list of component PJs. The remnant PDS (or the original PDS, if no threshold criteria was met) can be summed and root squared to produce an RMS value for RJ.

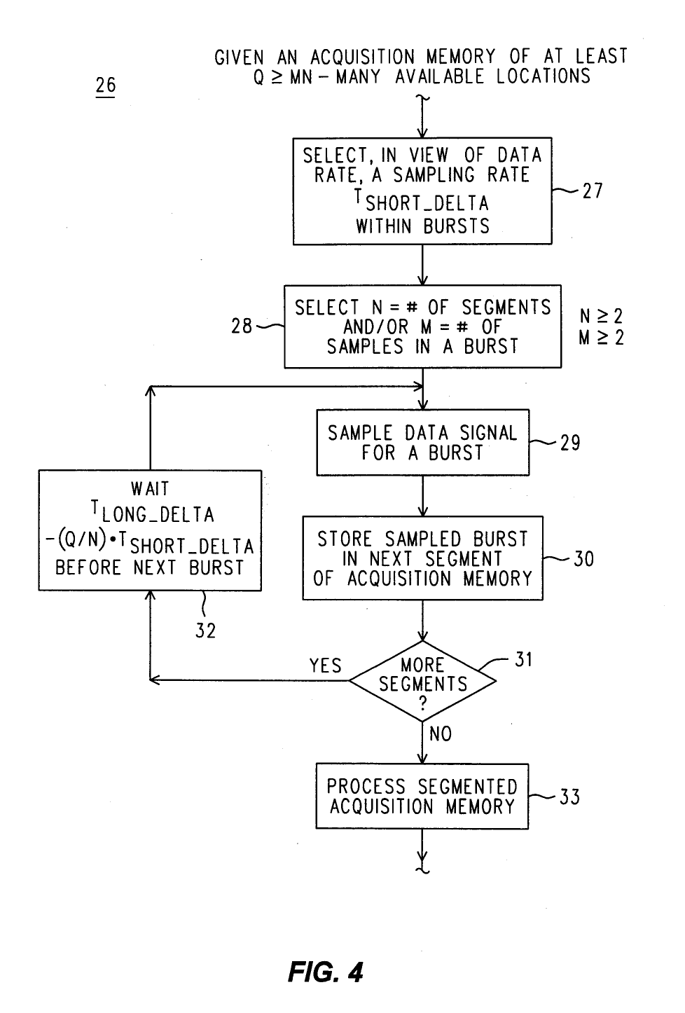

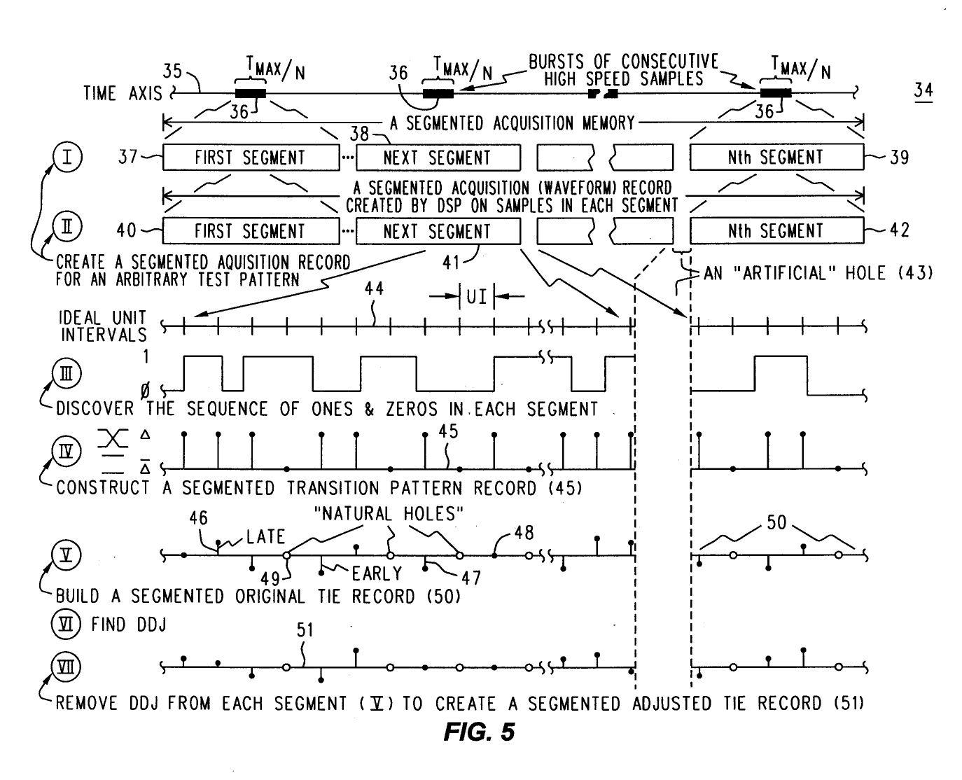

The preceding three paragraphs are essentially the Simplified Description (Summary) of the incorporated FINDING RANDOM JITTER IN AN ARBITRARY NON-REPEATING DATA SIGNAL, and a more thorough explanation may be found in the text describing FIGS. 4 and 5 of that application. What is of interest to us at present is that, even though it won't characterize long period jitter, the technique described in FINDING RANDOM JITTER IN AN ARBITRARY NON-REPEATING DATA SIGNAL tolerates holes. Crudely put, we plan to take an Acquisition Memory that is ‘too short’, divide it into segments, and then ‘stretch it’ by adding ‘artificial holes’ between the segments (while leaving the segments themselves intact) so that it is ‘long enough’ for measurement of the long period jitter that we are interested in. In essence, we are going to sample the long period jitter. However, in the process we won't neglect or inadvertently relinquish the ability to sample any high frequency jitter to be measured, since within each burst we will be characterizing the corresponding segment of the waveform with a significant number of consecutive high speed samples.

We now return to the problem at hand concerning long period jitter, and address the issue of a creating a Segmented Original Acquisition Record that contains useful information about a high speed signal that has both ‘long’ and ‘short’ period jitter (and for that matter, might have jitter of any period within the range of ‘long’ to ‘short’).

As a point of departure, there is a heuristic from the DSP community that says: “If you give me at least two points along each cycle of the highest frequency sinusoid contained in some complex waveform, I can create a pretty decent re-construction of that cycle which will work for most purposes, although more samples is better, and equally space samples are much more convenient for computational purposes.” What is true for the highest frequency component of interest is also true for one of a lower, or even the lowest, frequency component. So, we would prefer at least two equally spaced samples for any long period periodic jitter we intend to measure. Suppose, for the sake of example only, that we arbitrarily decide to make five equally spaced samples over a period T_{LONG}_{_{—}}_{PERIOD}. (Where T_{LONG}_{_{—}}_{PERIOD} is selected in anticipation of the longest period jitter we expect to find or would be interested in.) Let T_{LONG}_{_{—}}_{PERIOD} begin at T₀, and let T_{LONG}_{_{—}}_{DELTA}=T_{LONG}_{_{—}}_{PERIOD}/5. We thus desire to sample our data at these five times:

T₁=T₀

T₂=T₀+T_{LONG}_{_{—}}_{DELTA}

T₃=T₀+2T_{LONG}_{_{—}}_{DELTA}

T₄=T₀+3T_{LONG}_{_{—}}_{DELTA}

T₅=T₀+4T_{LONG}_{_{—}}_{DELTA}

Clearly, we are not interested in taking a total of just five samples! We never said what we actually have available as a size for the Acquisition Memory. It doesn't really matter, so long as it is ‘enough,’ where that is apt to be anywhere from a few megabytes to perhaps many hundreds of megabytes. As we said earlier, high-end DSOs tend to come with as much memory as is practical, and one goes forth from there with what is available. So, suppose Q is the size (say, in ‘samples’) of the Acquisition Memory, and that, as before, at the maximum sample rate (T_{SHORT}_{_{—}}_{DELTA}) this gives a length of time T_{MAX} for continuous sampling at the sustained maximum sample rate. Let us say that T_{LONG}_{_{—}}_{PERIOD}=NT_{MAX}. N represents an integral number of segments. (For the sake of simplicity, let N be an integer, or if that seems unfair, truncate it so that it is, anyway, or, adjust T_{LONG}_{_{—}}_{PERIOD} so that it matches an N that has been rounded.) Now our plan is to make a burst of Q/N consecutive high speed measurements beginning at each of the five different Tᵢ. (And also for the sake of continued simplicity, we either agree that Q/N is an integer, or, truncate it so that it is.) So, and returning to the example, instead of taking just five samples, we plan to take five bursts (N=5) of high speed samples (Q/5 in number, T_{SHORT}_{_{—}}_{DELTA} apart). Must it be five bursts? No! We just picked that number as an example that will work. It might be a few as two, or perhaps three. More is better, up to the point where there are not enough consecutive samples in the burst to resolve the tiny time intervals (we assume that Q/5 is enough samples in a burst to accomplish that, and that Q/10 or Q/30 might do as well, but Q/100 might not—depending on Q). Since the time between the start of the bursts is T_{LONG}_{_{—}}_{DELTA} and the length of a burst is (QT_{LONG}_{_{—}}_{DELTA})/N, the time between bursts is T_{LONG}_{_{—}}_{DELTA}−(QT_{SHORT}_{_{—}}_{DELTA})/N, and is the size of the ‘artificial holes’ that we have added to ‘stretch’ the Acquisition Record.

Finally, in principle the bursts need not be equally spaced, nor do the samples within a burst. In practice it is most convenient if the samples within bursts all occur at a regular rate, and if the bursts occur at a regular rate, too. Otherwise, we would need to keep careful track of the actual times that the samples were taken (as opposed to just letting it be implicit in the computations), and, we would lose the ability to employ certain streamlined algorithms that the DSP community has developed to ease the number and complexity of the numerical operations to be performed (e.g., avoidance of an infinite number of summations of a translated sinc function . . . ).

Now refer to FIG. 4, which is a simplified flowchart 26 describing the process of sampling M-many samples in N-many bursts to fill an Acquisition Memory of Q≧NM available locations. At step 27 a sampling rate (T_{SHORT}_{_{—}}_{DELTA}) is selected for use within each burst. This selection made in view of the data signal's bandwidth, and by the Sampling Theorem must be a length of time short enough to represent the fall bandwidth of the data signal. A typical value for M might be Q/8. At step 28 the number of segments N and the number of samples M in a segment are selected. We shall for convenience make the bursts uniformly separated. To avoid haggling over the conditions at the very limit, we either accept a slightly shorter long period if N is two, or insist that N be at least three. A typical value for N might be eight to ten.

At step 29 the data signal is sampled at a rate of T_{SHORT}_{_{—}}_{DELTA} samples per second to obtain M-many samples for a single burst. At step 30 the sampled data for that burst is stored in the next segment of the Acquisition Memory. Of course, we don't envision that the Acquisition Memory is physically partitioned into segments (we suppose it could be, but at present we don't need to . . . ), and expect instead that a segment is enforced just by an understanding that it amounts to some group of consecutive addresses.

Step 31 determines if all segments have received data from a burst. If not, then step 32 waits T_{LONG}_{_{—}}_{DELTA}−(QT_{SHORT}_{_{—}}_{DELTA})/N before returning again to step 29 to sample for the next burst. If all bursts have been taken and stored in a segment, then step 31 transitions to step 33, where the content of the Segmented Acquisition Memory is processed to find long and short period jitter.

Now refer to FIG. 5, which comprises a diagram 34 similar to FIG. 3, but where the sampling is conducted in bursts, in a manner consistent with what is described in the preceding paragraphs. FIG. 5 illustrates a series of initial or preliminary steps that may be performed in preparation for separating RJ from PJ in an arbitrary non-repeating data signal.

At the top of the figure is a Time Axis 35 along which have been depicted a series of N-many time intervals 36 that represent the bursts of samples that will be taken. These burst 36 may be thought of as Tₘₐₓ/N in length, or, as being M(T_{SHORT}_{_{—}}_{DELTA}) in length.

In Step I the various segments (27, 38, . . . 39) of a Segmented Acquisition Memory are shown.

In Step II an arbitrary Test Pattern is represented in a Segmented Acquisition Record (40, 41, . . . 42) as consecutive samples meeting the Sampling Theorem's requirements. This Segmented Acquisition Record is created by a suitable measurement process (probably assisted by DSP performed upon the corresponding segments in the Acquisition Memory, and is almost certainly a tabular representation of times-of-transitions), and is the basis for the jitter measurements to follow. The Test Pattern is, in principle, arbitrary, in that it may be random data, live data or some other favorite sequence of bits prized for some special property. Pseudo random data is usually ideal for this purpose, although it is believed that live data generally works about as well provided that a long enough Acquisition Record is obtained.

For convenience, a time scale 44 of ideal unit intervals is included in proper alignment with the sections below it. This is useful, as there are edges shown as part of Step III that, owing to jitter, do not transition at the edges of a UI.

In Step III the bit pattern for the arbitrary Test Pattern is discovered, if it is not already known. For example, the discovery may be made in a real time DSO environment, where the Acquisition Record is consecutive digitized samples, by applying DSP to those samples to obtain a rendered result that is suitably dense and then comparing that against a threshold that is, say, midway between average maximum and average minimum values. We have shown the information found in Step III as a waveform corresponding to the meaning of the Segmented Acquisition Record (40, 41, . . . 42) of Step II, as this visual device comports well with the Segmented TIE Record of Step V; in an actual system the information of Step III might be just a table indexed by consecutive ordinals corresponding to the consecutive UIs.

Step IV is the construction of a Segmented Transition Pattern (STP) Record 45, which we show in the same general format as for normal TIE Records (it was convenient) but which in an actual system might also be just a table indexed by consecutive ordinals corresponding to the consecutive UIs.

In Step V a complete Segmented Original TIE Record (50) is created from an inspection of the bit pattern produced in Step III. As described in connection with the bottom portion of FIG. 3, each edge in the Test Pattern gets a signed value that is the error in expected time of occurrence for that edge. Ascending lines and dots (e.g., 46) indicate late transitions, descending lines and dots (e.g., 47) represent early transitions, while in each case the length of the lines represents the amount of the error. A dot (e.g., 48) directly upon the abscissa indicates a zero length line, and no error for the corresponding edge. Natural holes caused by an absence of a transition in the Test Pattern are indicated by empty circles (49). Of course, the Segmented TIE Record is numerical data stored in a memory-based data structure, and is not actually stored as an image as is seen in the figure. (It will naturally be appreciated that the image in the figure is merely a convenient way to indicate the kind of information that is in the data structure.)

Step VI is the optional discovery of DDJ. We have no truly graceful way to indicate the result (with DDJ cause and effect can be widely separated, and an effect can seem to ‘precede’ its cause . . . ), although we could make it look like a TIE Record. In any event, Step VI probably produces another table.

Step VII is the creation of a Segmented Adjusted TIE Record 51 that is the Segmented Original TIE Record 50 of Step V after having the DDJ of Step VI removed. (Assuming DDJ was found. If DDJ is not an issue, then just assume that all values of DDJ are zero, and the Segmented Adjusted TIE Record and the Segmented Original TIE Record are simply the same.) And although we have shown it in graphical form, Segmented Adjusted TIE Record 51 (and the Segmented Original TIE Record 50) are almost certainly implemented as tables or other data structures in memory. No great complexity needs to permeate this Step VII, and it can be as simple as signed addition between corresponding elements of the Original TIE Record and the sequential elements of the record for DDJ. On the other hand, we do acknowledge that there operating environments where the amounts of jitter can exceed a UI, and that may entail some appropriate sophistication in understanding exactly what the correspondence is between ‘corresponding’ elements. Enough said.

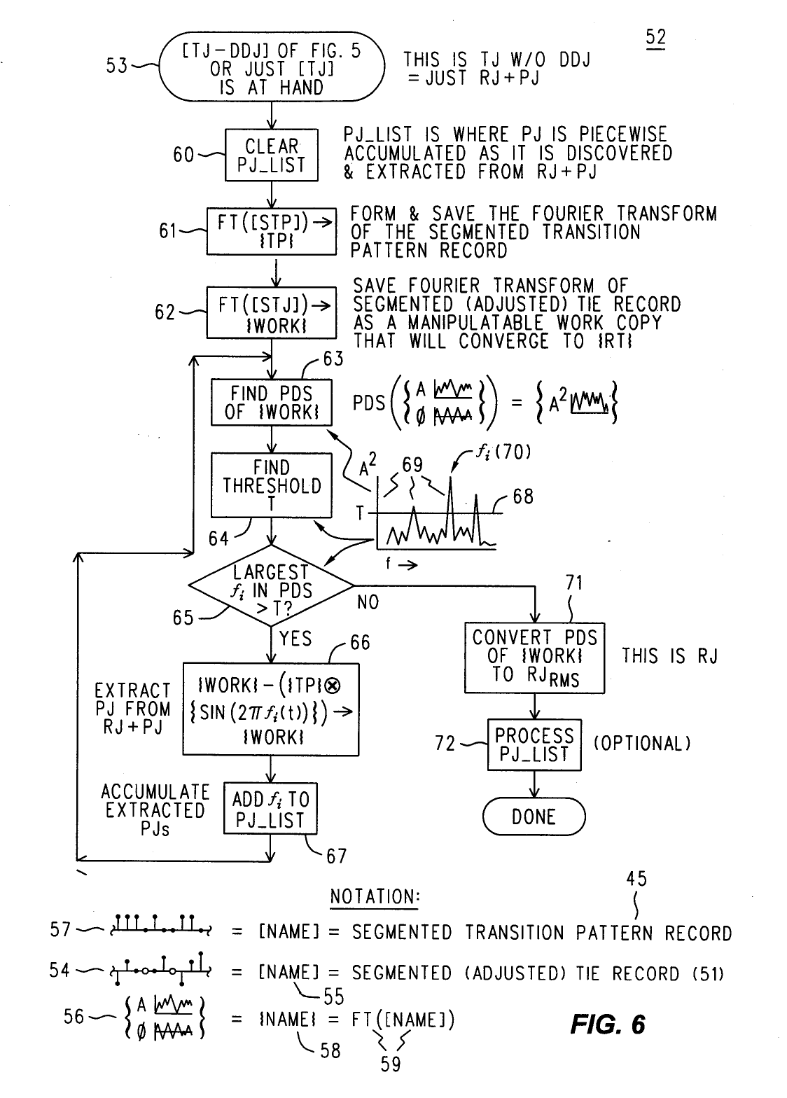

Finally, consider FIG. 6. It is is an annotated simplified flowchart 52 describing how the result of Step VII of FIG. 5 may be processed to isolate RJ from RJ+PJ. (FIG. 6 is an adjusted version of FIG. 5 in the incorporated FINDING RANDOM JITTER IN AN ARBITRARY NON-REPEATING DATA SIGNAL.) At the start 53 of the flowchart 52 the initial conditions might be that the activity of FIG. 5 has been accomplished, and that as an input quantity the Segmented Adjusted Tie Record (51 of FIG. 5) is at hand. The notation we used to indicate this quantity is [NAME] (in this case, [TJ−DDJ] ), as explained in legends 54, 55, 56, 57, 58 and 59 at the bottom of the figure. On the other hand, it might be the case that the environment that produced the measurements of RJ+PJ have no significant DDJ, that TJ is essentially RJ+PJ, and that Step VI of FIG. 5 is inappropriate or unnecessary. In such a case it will be understood that the subtraction indicated in [TJ−DDJ] is either harmless (i.e., is equivalent to [TJ−0] ) or is simply omitted in favor of using [TJ] in place of the indicated difference. In other words, we do not require that there be a removal of DDJ from TJ before the activity of the flowchart 52 is begun to separate RJ and PJ. We do suggest, however, that persons skilled in the jitter arts will appreciate that if there is significant DDJ present in TJ, then it is wise to remove it, as its presence, if continued, will generally corrupt the Fourier Transforms of FIG. 6, and cast some degree of doubt upon the validity of the results.

In step 60 a thing called PJ_LIST is cleared. PJ_LIST can be a simple data structure that is used to record the frequency components that are discovered as contributing to PJ.

In step 61 the Fourier Transform (FT) of the Transition Pattern (TP) is formed; the notation is FT([TP])→{TP}, and is consistent with the legends 54-59 at the bottom of the figure. What this does is create ahead of time an FT (namely, {TP}) that will be used as a constant in an iterative loop of steps 63, 64, 65, 66 and 67.

Next, at step 62 we find a work copy of a Fourier Transform {WORK} that starts out as FT([TJ]). This quantity will be manipulated by removing iteratively discovered PJ-related frequency components, so that {WORK} will converge toward {RJ}.

At step 63 we enter the top of the iterative loop proper. At this step we find the Power Density Spectrum (PDS) of {WORK}. As shown in the accompanying legend, this is accomplished by squaring the amplitude component and discarding the phase component.

At step 64 a threshold T (68) is found from an analysis of the PDS (69) found in step 63. We can think of the PDS as containing ‘grass’ and ‘trees’. The ‘grass’ is just noise that can ignored, while the ‘trees’ represent periodic signals that are almost certainly related to PJ. One way to find the threshold T is to simply average all the values in the record, and set T as some related value, say, 110% of that average. The expected situation is shown in the diagram 69 to the right of step 64. We expect that ofttimes there will be peaks in the PDS (‘trees’) that extend above the threshold T (68). One such peak (70) represents the frequency components fᵢ.

Now, in step 65 the question is asked: does the largest fᵢ in the PDS of steps 63 and 64 exceed the threshold T? There are a number of alternate and generally equivalent ways this basic question might be framed, including the trivial variations of including equality in the comparison. In any event, if the answer is NO, then there are two cases. The first is that there have been no iterations (YES answers) and that evidently there is no significant PJ, which is to say that all of RJ+PJ is just RJ. But that is what is represented by {WORK} at this point (it never got changed!), so at step 71 we convert that to an RMS value for RJ (namely, RJ_{RMS}). On the other hand, if there have been iterations (previous YES answers at qualifier 65), {WORK} will have previously been diminished by the various PJ components that have been identified, and step 71 is still correct.

To conclude the NO branch from qualifier 65, the step 72 after step 71 is the optional processing of PJ_LIST to create a value for discovered PJ. This may be accomplished in a manner that is already known in the art. Once that is accomplished (or not) an instance of activity for flowchart 52 has been concluded.

We, however, have not yet concluded our description of flowchart 52, as the YES branch from qualifier 65 remains still to be described. That YES branch leads to step 66, where the PJ-related frequency component (fᵢ-70) is removed from RJ+PJ, and the diminished result saved back in {WORK}. This is the essence of the ‘synthetic de-convolution’ mentioned earlier.

Here is some additional detail concerning step 66. Subsequent to a Fourier transformation, let us denote as Aᵢ and Pᵢ the respective amplitude and phase of the complex value of the frequency component, fᵢ. The symbol \textcircled{×}, as before, represents convolution. Keep in mind that an individual PJ frequency component (sine wave in the time domain) fᵢ, would not be manifest in {WORK} as a single complex value at location fᵢ. It would instead appear as the FT of the PJ sine wave convolved with the FT of PT. This will be so because the presence of holes (whether ‘natural’ or ‘artificial’) in the Segmented Adjusted TIE Record act like amplitude modulation of the PJ by the Transition Pattern (TP). So when we say we remove the frequency component fᵢ from {WORK}, we mean to remove the quantity {Aᵢ cos(2πtfᵢ+Pᵢ)} \textcircled{×} {TP} from {WORK}. This will, of course, be a complex subtraction, since each of the transforms {Aᵢ cos( . . . )} \textcircled{×} {TP} and {WORK} has both a phase and an amplitude.

The final step 67 in the iterative loop is to incorporate fᵢ into PJ_LIST. Following that the iterative loop is closed by a return to step 63, where a new PDS for the diminished {WORK} is found, followed by the finding of a new threshold T, etc.

I claim:

1. A method of measuring short and long period timing jitter in a digital signal that exhibits transitions in logical value at the conclusion of unit intervals, the method comprising the steps of:
(a) sampling the digital signal in bursts, the rate of consecutive sampling in each burst being at least twice the frequency of the highest spectral component of interest in the digital signal;
(b) storing each burst of samples in a respective and corresponding segment of a segmented acquisition memory having at least two segments;
(c) repeating steps (a) and (b) at a rate that fills the segmented acquisition memory in approximately, but at least as long as, the period of the longest long period timing jitter to be measured in the digital signal, until all the segments in the segmented acquisition memory store a burst of samples;
(d) subsequent to step (c), processing the content stored in the segmented acquisition memory to produce a corresponding segmented transition pattern record;
(e) subsequent to step (d), processing the segmented acquisition pattern record to produce a corresponding segmented time interval error record;
(f) the segments of the segmented time interval error record containing natural holes at locations where two or more consecutive unit intervals of the digital signal had the same logical value;
(g) processing the segmented time interval error record to measure the periods of jitter represented therein with an algorithm that tolerates natural holes and that construes the interval between segments as artificial holes to be treated as extended natural holes.

2. A method as in claim 1 wherein step (d) further comprises the step of first using digital signal processing to reconstruct from the content stored in each segment a corresponding segment of a segmented waveform record, and wherein the remainder of step (d) then operates on the segments of the segmented waveform record.

3. A method as in claim 1 further comprising, after step (e), the steps of discovering and removing values of data dependent timing jitter to produce a segmented adjusted time interval error record, and wherein the time interval error record processed by step (g) is the adjusted time interval error record.

4. A method as in claim 1 wherein step (g) further comprises the steps of.
(h) forming the Fourier transform of the entire segmented transition pattern record of step (d);
(I) forming a work Fourier transform equal to the Fourier transform of the entire segmented time interval error record of step (e);
(j) forming a power density spectrum of the work Fourier transform;
(k) subsequent to step (j), selecting a threshold that separates noise components within the power density spectrum of step (j) from peaks therein that are likely components of periodic timing jitter;
(l) determining if a largest peak within the power density spectrum of step (j) exceeds the threshold selected in step (k);
(m) only if the determination in step (l) is in the negative, then converting the work Fourier transform into a value to be understood as random timing jitter, else;
(n) only if the determination in step (l) is in the affirmative, then diminishing the work Fourier transform by the convolution of the Fourier transform of the entire segmented transition pattern record with the Fourier transform of the sine of a frequency corresponding to the largest peak determined in step (l); and then
(o) repeating steps (j), (k), (l) and (n) until step (m) has been performed.

5. A method as in claim 4 further comprising, subsequent to step (e) and prior to step (I), the steps of determining data dependent timing jitter and of removing the effects of that data dependent timing jitter from the segmented time interval error record of step (e).

6. A method as in claim 4 wherein step (n) further comprises retaining a record of frequencies corresponding to the largest peaks and step (m) further comprises converting that record of frequencies into a value to be understood as periodic timing jitter.

7. A method as in claim 1 wherein the digital signal is a single instance of a non-repeating bit pattern.

8. A method as in claim 1 wherein the digital signal is an arbitrary bit pattern.

9. A method as in claim 1 wherein the timing jitter is periodic.

10. A method as in claim 1 wherein the timing jitter is random.

11. A method as in claim 1 wherein step (c) repeats steps (a) and (b) at a rate that produces equally spaced bursts.

12. An apparatus that performs the method of claim 1.

13. Apparatus as in claim 12 wherein the apparatus comprises a digital oscilloscope.
